(19) United States
(12) Patent Application Publication
(10) Pub. No.: US 2019/0382015 A1
(43) Pub. Date: Dec. 19, 2019

(54) CONTROL DEVICE FOR VEHICLE

(71) Applicant: Honda Motor Co.,Ltd., Tokyo (JP)

(72) Inventors: Chao NIU, Saitama (JP); Takashi ADACHI, Saitama (JP); Kazunori MIYATA, Saitama (JP)

(73) Assignee: Honda Motor Co.,Ltd., Tokyo (JP)

(21) Appl. No.: 16/439,715

(22) Filed: Jun. 13, 2019

(30) Foreign Application Priority Data
Jun. 14, 2018 (JP) 2018-114019

(51) Int. Cl. B60W 30/182; B60W 10/04; B60W 50/08; B60W 30/09

(52) U.S. Cl. CPC B60W 30/182; B60W 10/04; B60W 10/18; B60W 30/09; B60W 50/087

(57) ABSTRACT

The disclosure provides a control device for a vehicle, as an acceleration priority shift control that selects the shift stage set by the automatic transmission (TM) by preferentially using the information of acceleration of the vehicle (1), the traveling control part (120) calculates a maximum acceleration (Gmax) and a minimum acceleration (Gmin) of the vehicle (1) by using external information of the vehicle (1); calculates a target acceleration (Gt) by comparing the calculated maximum acceleration (Gmax) and minimum acceleration (Gmin) with a preset optimum acceleration (Gi); calculates a target shift stage (SHt) of the automatic transmission (TM) based on a current state of an engine (EG) in accordance with the calculated target acceleration (Gt); and calculates a standby pressure (Pm) for a clutch of the calculated target shift stage (SHt), and performs standby pressure control of the clutch with the calculated standby pressure (Pm).

### CROSS-REFERENCE TO RELATED APPLICATION

This application claims the priority benefit of Japan application serial no. 2018-114019, filed on Jun. 14, 2018. The entirety of the above-mentioned patent application is hereby incorporated by reference herein and made a part of this specification.

### BACKGROUND

### Technical Field

The disclosure relates to a control device for a vehicle, and particularly relates to a control device for a vehicle, which performs automatic driving control to automatically control at least one of acceleration, deceleration, and steering of the own vehicle.

### Description of Related Art

As disclosed in Patent Document 1, for example, there is a conventional control device for a vehicle, which includes an automatic driving control part that automatically controls at least one of acceleration, deceleration, and steering of the own vehicle for the own vehicle to travel along a route to the destination. In addition, among vehicles equipped with such an automatic driving control part, there is a vehicle that includes a stepped automatic transmission capable of setting multiple shift stages having different gear ratios, and the automatic driving control part has a traveling control part that outputs a command value of traveling control which includes selecting a shift stage set by the automatic transmission.

In the control of acceleration and deceleration of the vehicle under automatic driving control as described above, a main control method for selecting the shift stage of the automatic transmission in the conventional control is to select the shift stage based on a vehicle speed feedback signal or an accelerator pedal opening degree signal which is based on the driver's operation. However, in the case where the shift stage is selected based on the vehicle speed feedback or the accelerator pedal opening degree, particularly when the vehicle is going to change the lane, the shift stage that gives priority to reaching the requested acceleration is selected, so a shock (vibration and noise) may be generated as the shift stage is switched, and it may affect the comfort (ride comfort) of the occupant of the vehicle.

### RELATED ART

### Patent Document

### [Patent Document 1] Japanese Laid-open No. 2017-146819

### SUMMARY

In view of the above, the disclosure provides a control device for a vehicle, which makes it possible to select a shift stage that gives priority to occupant comfort in the control of acceleration and deceleration of the vehicle under automatic driving control.

In view of the above, a control device 100 for a vehicle according to the disclosure includes an automatic driving control part 110 that performs an automatic driving control for automatically controlling at least acceleration and deceleration of the vehicle 1. The control device for the vehicle includes an automatic transmission TM shifting a rotation of a driving force transmitted from a drive source EG of the vehicle 1 and outputting it to a drive wheel side, wherein the automatic transmission TM is a stepped automatic transmission capable of setting a plurality of shift stages having different gear ratios. The control device 100 includes: a traveling control part 120 outputting a command value of a traveling control which includes a selection of a shift stage set by the automatic transmission TM, wherein, as acceleration priority shift control that selects the shift stage set by the automatic transmission TM by preferentially using an information of acceleration of the vehicle 1, the traveling control part 120: calculates a maximum acceleration Gmax and a minimum acceleration Gmin of the vehicle 1 by using an external information of the vehicle 1 acquired by an external information acquisition part 12; calculates a target acceleration Gt by comparing the calculated maximum acceleration Gmax and minimum acceleration Gmin with a preset optimum acceleration (ideal acceleration Gi); calculates a target shift stage SHt of the automatic transmission TM based on a current state of the drive source EG in accordance with the calculated target acceleration Gt; and calculates a standby pressure Pm for a friction fastening element of the calculated target shift stage SHt, and performs a standby pressure control of the friction fastening element with the calculated standby pressure Pm.

According to the control device for the vehicle of the disclosure, under selection control of the shift stage set by the automatic transmission, the target shift stage is determined based on the target acceleration of the vehicle, so that it is possible to determine the target shift stage with acceleration considering the condition of the lane traveled by the vehicle based on the optimum acceleration. Therefore, the target shift stage of the automatic transmission is determined before the actual acceleration is permitted based on information such as the accelerator pedal opening degree, and the standby pressure of the friction fastening element corresponding to the target shift stage is controlled, thereby effectively reducing the occurrence of shift shock. In addition, since it is unnecessary to downshift in advance, the occupant will not feel uncomfortable due to a rise (blow-up) of the rotation speed of the drive source (engine) caused by the downshift.

Also, in the control device for the vehicle according to the disclosure, the traveling control part 120 is capable of selectively performing the acceleration priority shift control and a normal shift control, which selects the shift stage of the automatic transmission TM based on an accelerator pedal opening degree signal or a vehicle speed feedback signal, as selection control of the shift stage of the automatic transmission TM, and in the acceleration priority shift control, the acceleration priority shift control may be shifted to the normal shift control after determining that it is possible for the vehicle 1 to change a lane or accelerate at a requested acceleration.

According to this configuration, in the acceleration priority shift control, after determining that it is possible for the vehicle to change the lane or to accelerate at the requested acceleration, the control is shifted to the normal shift control. Thereby, when acceleration required by the acceleration priority shift control is obtained, then the normal shift control is performed, so that the acceleration priority shift control can be performed only when there is concern about the occurrence of shift shock, such as lane change or acceleration at the requested acceleration. Accordingly, the traveling performance of the vehicle can be improved.

Further, in the control device for the vehicle according to the disclosure, the external information acquisition part 12 may include at least one of an imaging device capable of imaging outside of the vehicle 1, a radar detection part acquiring external information of the vehicle 1 by a radar, and an inter-vehicle communication part capable of communicating with another vehicle.

According to this configuration, the external information acquisition part includes at least one of the imaging device capable of imaging the outside of the vehicle, the radar detection part acquiring external information of the vehicle by the radar, and the inter-vehicle communication part capable of communicating with another vehicle, so that it is possible to properly acquire the external condition of the vehicle by the external information acquiring part and to acquire more appropriate information as the acceleration information required for selecting the shift stage.

In addition, in the control device for the vehicle according to the disclosure, the drive source EG may be an engine EG, and in the standby pressure control of the friction fastening element, an engine rotation speed limit that limits a rotation speed of the engine EG to a predetermined rotation speed or less is performed.

According to this configuration, by performing the engine rotation speed limit for limiting the rotation speed of the engine in the standby pressure control of the friction fastening element, the acceleration of the vehicle can be changed smoothly. As a result, comfort of the occupant (ride comfort) can be ensured. Also, when the vehicle travels at a constant vehicle speed, there is a possibility that the vehicle speed (vehicle body speed) cannot be kept constant due to the standby pressure control, and the deceleration may make the occupant uncomfortable. To cope with this, limiting the engine rotation speed can prevent an excessive rise of the engine rotation speed (so-called blow-up). Therefore, by limiting the engine rotation speed in the standby pressure control, it is possible to reduce both the blow-up of the engine and the deceleration. The reference numerals in parentheses above indicate drawing reference numerals of the corresponding components in the embodiments described later for reference.

The control device for a vehicle according to the disclosure makes it possible to select the shift stage that gives priority to occupant comfort in the control of acceleration and deceleration of the vehicle under automatic driving control, and can effectively improve the ride comfort of the vehicle.

### BRIEF DESCRIPTION OF THE DRAWINGS

FIG. 1 is a functional configuration diagram of the control device for a vehicle, which is an embodiment of the disclosure.

FIG. 2 is a schematic diagram showing a configuration of the traveling driving force output device (driving device) for a vehicle.

FIG. 3 is a flowchart for illustrating a procedure of acceleration priority shift control.

FIG. 4 is a flowchart for illustrating a procedure of target acceleration calculation.

FIG. 5 is a flowchart for illustrating a procedure of target shift stage calculation.

FIG. 6 is a flowchart for illustrating a procedure of standby pressure control.

FIG. 7 is a diagram for illustrating the elements used for calculation of each value in acceleration priority shift control.

FIG. 8 is a timing chart for illustrating a procedure of acceleration priority shift control.

### DESCRIPTION OF THE EMBODIMENTS

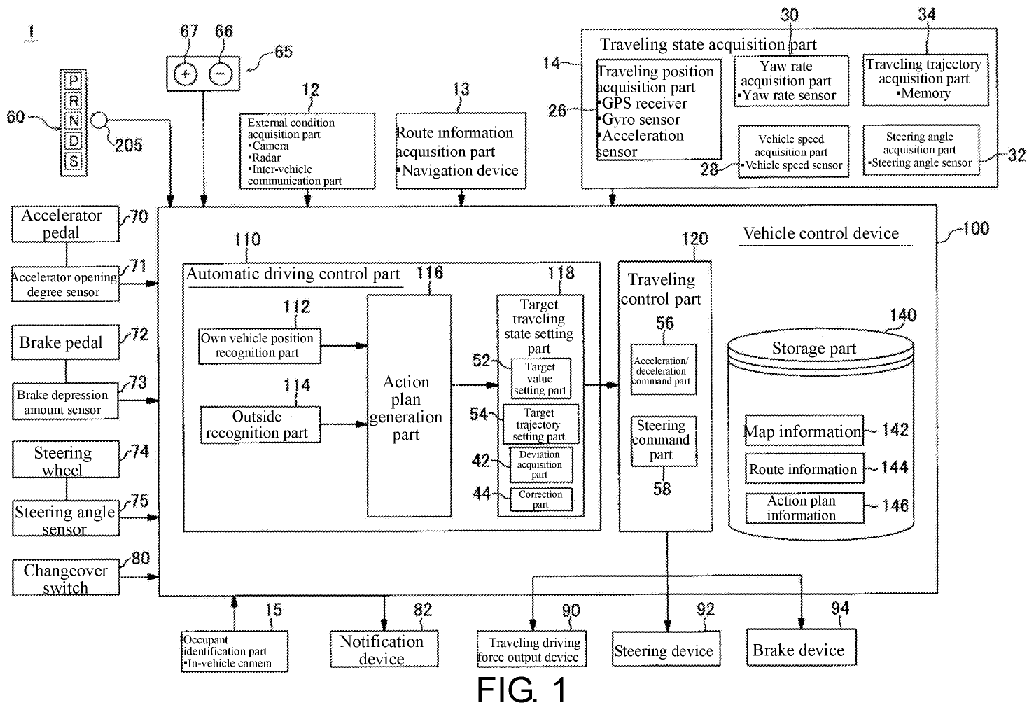

Embodiments of the disclosure will be described below with reference to the accompanying drawings. FIG. 1 is a functional configuration diagram of a control device 100 mounted on a vehicle 1. A configuration of the control device 100 will be described with reference to FIG. 1. The vehicle (own vehicle) 1 on which the control device 100 is mounted is a two-wheeled, three-wheeled, or four-wheeled automobile, for example, and includes an automobile powered by an internal combustion engine such as a diesel engine or a gasoline engine, an electric automobile powered by an electric motor, a hybrid automobile having both an internal combustion engine and an electric motor, and the like. Further, the above-mentioned electric automobile is driven using electric power discharged by a battery such as a secondary battery, a hydrogen fuel cell, a metal fuel cell, and an alcohol fuel cell.

The control device 100 includes part for taking in various types of information from the outside of the vehicle 1, such as an external condition acquisition part 12, a route information acquisition part 13, a traveling state acquisition part 14, etc. The control device 100 also includes operation devices such as an accelerator pedal 70, a brake pedal 72, a steering wheel 74, a changeover switch 80, etc., operation detection sensors such as an accelerator opening degree sensor 71, a brake depression amount sensor (brake switch) 73, a steering angle sensor (or a steering torque sensor) 75, etc., a notification device (output part) 82, and an occupant identification part (in-vehicle camera) 15. Further, a traveling driving force output device (driving device) 90, a steering device 92, and a brake device 94 are provided as devices for driving or steering the vehicle 1, and the control device 100 is provided for controlling them. These devices and machines are connected to one another by using CAN (controller area network) communication lines such as multiple communication lines or serial communication lines, through a wireless communication network, or the like. Nevertheless, the illustrated operation devices are merely examples, and buttons, dial switches, GUI (graphical user interface) switches, or the like may be mounted on the vehicle 1.

The external condition acquisition part 12 is configured to acquire the external condition of the vehicle 1, for example, environment information of the surroundings of the vehicle such as the lane of the traveled road and objects around the vehicle. The external condition acquisition part 12 includes, for example, various cameras (monocular camera, stereo camera, infrared camera, etc.), various radars (millimeter wave radar, microwave radar, laser radar, etc.), an inter-vehicle communication device (inter-vehicle communication part) capable of performing communication of position information, etc. with another vehicle, or the like. It is also possible to use a fusion sensor that integrates the information obtained by the cameras and the information obtained by the radars.

The route information acquisition part 13 includes a navigation device. The navigation device has a GNSS (global navigation satellite system) receiver or map information (navigation map), a touch panel display device functioning as a user interface, a speaker, a microphone, etc. The navigation device identifies the position of the vehicle 1 by the GNSS receiver and derives a route from the position to the destination designated by the user. The route derived by the navigation device is stored in the storage part 140 as route information 144. The position of the vehicle 1 may be identified or supplemented by INS (inertial navigation system) using the output of the traveling state acquisition part 14. In addition, when the control device 100 is executing a manual driving mode, the navigation device guides the driver along the route to the destination by voice or navigation display. The configuration for identifying the position of the vehicle 1 may be provided independently of the navigation device. Further, the navigation device may be realized by a function of a terminal device such as a smartphone or a tablet terminal held by the user, for example. In that case, information is exchanged between the terminal device and the control device 100 by wireless or wired communication.

The traveling state acquisition part 14 is configured to acquire the current traveling state of the vehicle 1. The traveling state acquisition part 14 includes a traveling position acquisition part 26, a vehicle speed acquisition part 28, a yaw rate acquisition part 30, a steering angle acquisition part 32, and a traveling trajectory acquisition part 34.

The traveling position acquisition part 26 is configured to acquire the traveling position of the vehicle 1 and the attitude (traveling direction) of the vehicle 1, which are one of the traveling states. For example, the traveling position acquisition part 26 includes various positioning devices such as devices (GPS receiver, GNSS receiver, beacon receiver, etc.) that receive electromagnetic waves transmitted from a satellite or a road device to acquire position information (latitude, longitude, altitude, coordinates, etc.), a gyro sensor, an acceleration sensor, or the like. The traveling position of the vehicle 1 is measured with reference to a specific part of the vehicle 1.

The vehicle speed acquisition part 28 is configured to acquire the speed (referred to as the vehicle speed) of the vehicle 1, which is one of the traveling states. For example, the vehicle speed acquisition part 28 includes a speed sensor or the like provided on one or more wheels.

The yaw rate acquisition part 30 is configured to acquire the yaw rate of the vehicle 1, which is one of the traveling states. For example, the yaw rate acquisition part 30 includes a yaw rate sensor or the like.

The steering angle acquisition part 32 is configured to acquire the steering angle, which is one of the traveling states. For example, the steering angle acquisition part 32 includes a steering angle sensor provided on a steering shaft. Here, the steering angle speed and steering angle acceleration are also acquired based on the acquired steering angle.

The traveling trajectory acquisition part 34 is configured to acquire information of the actual traveling trajectory of the vehicle 1, which is one of the traveling states. The actual traveling trajectory includes the trajectory (locus) actually traveled by the vehicle 1 and may include a trajectory planned to be traveled from now on, for example, an extended line on the front side in the traveling direction of the traveled trajectory (locus). The traveling trajectory acquisition part 34 includes a memory. The memory stores position information of a series of point sequences included in the actual traveling trajectory. Moreover, the extended line can be predicted by a computer or the like.

The accelerator opening degree sensor 71, the brake depression amount sensor 73, and the steering angle sensor 75 which are the operation detection sensors output the accelerator opening degree, the brake depression amount, and the steering angle as detection results to the control device 100.

The changeover switch 80 is a switch operated by an occupant of the vehicle 1. The changeover switch 80 accepts the operation of the occupant and switches the driving mode (for example, automatic driving mode and manual driving mode) from the accepted operation content. For example, the changeover switch 80 generates a driving mode designation signal for designating the driving mode of the vehicle 1 from the operation content of the occupant, and outputs the driving mode designation signal to the control device 100.

Further, the vehicle 1 of the present embodiment includes a shift device 60 operated by the driver via a shift lever. The positions of the shift lever (not shown) in the shift device 60 include P (parking), R (reverse traveling), N (neutral), D (forward traveling in automatic shift mode (normal mode)), S (forward traveling in sports mode), or the like, as shown in FIG. 1, for example. A shift position sensor 205 is provided near the shift device 60. The shift position sensor 205 detects the position of the shift lever operated by the driver. Information of the shift position detected by the shift position sensor 205 is inputted to the control device 100. In the manual driving mode, the information of the shift position detected by the shift position sensor 205 is directly outputted to the traveling driving force output device 90 (AT-ECU 5).

Further, the vehicle 1 of the present embodiment includes a paddle switch 65 provided near the steering wheel 74. The paddle switch 65 includes a − switch (minus button) 66 for instructing a downshift in a manual shift mode during manual driving (manual driving mode), and a + switch (plus button) 67 for instructing an upshift in the manual shift mode. In the manual shift mode (manual mode) of the automatic transmission TM in the manual driving mode, the operation signals of the minus button 66 and the plus button 67 are outputted to the electronic control unit 100, and an upshift or a downshift of the shift stage set by the automatic transmission TM is performed according to the traveling state, etc. of the vehicle 1. In the present embodiment, during manual driving, for example, when the automatic shift mode is set with the position of the shift lever in the D range or the S range, if any of the minus button 66 and the plus button 67 is operated by the driver, the automatic shift mode is switched to the manual shift mode (manual mode). In addition, the function described in detail below with respect to the operation of the paddle switch 65 (a function different from that during manual driving) is given during automatic driving.

The notification device 82 includes various devices that can output information. The notification device 82 outputs information for urging the occupant of the vehicle 1 to shift from the automatic driving mode to the manual driving mode, for example. For example, at least one of a speaker, a vibrator, a display device, a light emitting device, or the like is used as the notification device 82.

The occupant identification part 15 includes an in-vehicle camera that can image the interior of the vehicle 1, for example. For example, the in-vehicle camera may be a digital camera using a solid-state imaging element such as CCD or CMOS, a near infrared camera combined with a near infrared light source, or the like. The control device 100 can acquire the image photographed by the in-vehicle camera and identify the current driver of the vehicle 1 from the image of the face of the driver of the vehicle 1 included in the image.

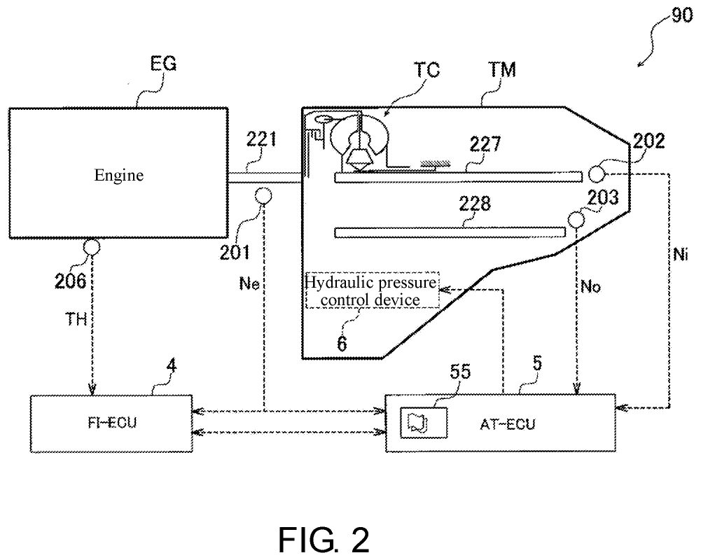

In the vehicle 1 of the present embodiment, as shown in FIG. 2, the traveling driving force output device (driving device) 90 includes an engine EG, an FI-ECU (electronic control unit) 4 for controlling the engine EG, the automatic transmission TM, and an AT-ECU 5 for controlling the automatic transmission TM. In addition to the above, in the case where the vehicle 1 is an electric automobile using an electric motor as the power source, the traveling driving force output device 90 may include a traveling motor and a motor ECU for controlling the traveling motor. In the case where the vehicle 1 is a hybrid automobile, it may include an engine, an engine ECU, a traveling motor, and a motor ECU. In the case where the traveling driving force output device 90 includes the engine EG and the automatic transmission TM, as in the present embodiment, the FI-ECU 4 and the AT-ECU 5 control the throttle opening degree of the engine EG, the shift stage of the automatic transmission TM, or the like according to the information inputted from a traveling control part 120 (which will be described later), and output a traveling driving force (torque) for the vehicle 1 to travel. In addition, in the case where the traveling driving force output device 90 includes only the traveling motor, the motor ECU adjusts the duty ratio of the PWM signal given to the traveling motor according to the information inputted from the traveling control part 120, and outputs the traveling driving force described above. Further, in the case where the traveling driving force output device 90 includes the engine and the traveling motor, both the FI-ECU and the motor ECU control the traveling driving force in cooperation with each other according to the information inputted from the traveling control part 120.

The steering device 92 includes an electric motor, for example. For example, the electric motor changes the direction of the steerable wheels by applying a force to a rack and pinion mechanism. The steering device 92 drives the electric motor according to the information inputted from the traveling control part 120 to change the direction of the steerable wheels.

The brake device 94 is an electric servo brake device including brake calipers, a cylinder transmitting hydraulic pressure to the brake calipers, an electric motor generating the hydraulic pressure in the cylinder, and a braking control part, for example. The braking control part of the electric servo brake device controls the electric motor according to the information inputted from the traveling control part 120, so that a brake torque (braking force output device) for outputting a braking force corresponding to the braking operation is outputted to each wheel. The electric servo brake device may include a mechanism, which transmits the hydraulic pressure generated by the operation of the brake pedal 72 to the cylinder via a master cylinder, as a backup. Nevertheless, the brake device 94 is not limited to the electric servo brake device described above, and may be an electronically controlled hydraulic brake device. The electronically controlled hydraulic brake device controls an actuator according to the information inputted from the traveling control part 120 to transmit the hydraulic pressure of the master cylinder to the cylinder. In addition, if the traveling driving force output device 90 includes the traveling motor, the brake device 94 may include a regenerative brake of the traveling motor.

Next, the control device 100 will be described. The control device 100 includes an automatic driving control part 110, the traveling control part 120, and the storage part 140. The automatic driving control part 110 includes an own vehicle position recognition part 112, an outside recognition part 114, an action plan generation part 116, and a target traveling state setting part 118. Each part of the automatic driving control part 110 and a part or all of the traveling control part 120 are realized by execution of a program performed by a processor such as a CPU (central processing unit). In addition, a part or all of these may be realized by hardware such as LSI (large scale integration) or ASIC (application specific integrated circuit).

Further, the storage part 140 is realized by ROM (read only memory), RAM (random access memory), HDD (hard disk drive), flash memory, or the like. The program executed by the processor may be stored in the storage part 140 in advance or may be downloaded from an external device via an in-vehicle Internet facility or the like. Moreover, the program may be installed in the storage part 140 by mounting a portable storage medium that stores the program in a drive device (not shown). In addition, the control device 100 may be distributed by a plurality of computer devices. Thereby, various processes in the present embodiment can be realized by cooperating the above-mentioned hardware functional parts and software composed of programs with the in-vehicle computer of the vehicle 1.

The automatic driving control part 110 performs control by switching the driving mode according to input of the signal from the changeover switch 80. The driving modes include a driving mode (automatic driving mode) that automatically controls the acceleration, deceleration, and steering of the vehicle 1, and a driving mode (manual driving mode) that controls acceleration and deceleration of the vehicle 1 based on the operation on operation devices such as the accelerator pedal 70 and the brake pedal 72 and controls steering based on the operation on operation devices such as the steering wheel 74, but the driving modes are not limited thereto. As another driving mode, for example, a driving mode (semi-automatic driving mode) may be included, which controls one of the acceleration, deceleration, and steering of the vehicle 1 automatically and controls another based on the operation on the operation devices. In the following description, “automatic driving” includes the semi-automatic driving mode in addition to the above-mentioned automatic driving mode.

When implementing the manual driving mode, the automatic driving control part 110 may stop the operation, and the input signal from the operation detection sensor may be outputted to the traveling control part 120 or may be supplied directly to the traveling driving force output device 90 (FI-ECU or AT-ECU), the steering device 92, or the brake device 94.

The own vehicle position recognition part 112 of the automatic driving control part 110 recognizes the lane (traveling lane) on which the vehicle 1 is traveling, and the relative position of the vehicle 1 with respect to the traveling lane based on the map information 142 stored in the storage part 140, and the information inputted from the external condition acquisition part 12, the route information acquisition part 13, or the traveling state acquisition part 14. The map information 142 is, for example, map information with higher accuracy than the navigation map included in the route information acquisition part 13, and includes information of the center of the lane or information of the boundary of the lane. More specifically, the map information 142 includes road information, traffic regulation information, address information (address/postal code), facility information, telephone number information, or the like. The road information includes information indicating types of roads such as expressways, toll roads, national highways, and prefectural roads, or information of the number of lanes on the road, the width of each lane, the gradient of the road, the position of the road (three-dimensional coordinates including longitude, latitude, and height), the curvature of the curve of the lane, the positions of the junction and branch point of the lanes, the signs provided on the road, or the like. The traffic regulation information includes information that the lane is blocked due to construction, traffic accidents, traffic jam, or the like.

For example, the own vehicle position recognition part 112 recognizes a deviation of the reference point (for example, the center of gravity) of the vehicle 1 from the center of the traveling lane, and the angle formed with respect to the line connecting the center of the traveling lane in the traveling direction of the vehicle 1 as the relative position of the vehicle 1 with respect to the traveling lane. Nevertheless, instead of the above, the own vehicle position recognition part 112 may also recognize the position of the reference point of the vehicle 1 with respect to any side end portion of the own lane as the relative position of the vehicle 1 with respect to the traveling lane.

The outside recognition part 114 recognizes the position and the state such as speed, acceleration, etc., of a surrounding vehicle based on the information inputted from the external condition acquisition part 12, etc. The surrounding vehicle in the present embodiment is another vehicle that travels around the vehicle 1 and is a vehicle that travels in the same direction as the vehicle 1. The position of the surrounding vehicle may be represented by a representative point such as the center of gravity or a corner of the vehicle 1 or may be represented by a region presented by the outline of the vehicle 1. The “state” of the surrounding vehicle may include whether the surrounding vehicle is accelerating or changing lane (or whether the surrounding vehicle is about to change lane) based on the information of the above various machines. The outside recognition part 114 may also recognize the positions of guardrails, utility poles, parked vehicles, pedestrians, or other objects in addition to the surrounding vehicle.

The action plan generation part 116 sets a start point of automatic driving, a planned end point of automatic driving, and/or a destination of automatic driving. The start point of automatic driving may be the current position of the vehicle 1 or the point where the occupant of the vehicle 1 performs the operation of instructing automatic driving. The action plan generation part 116 generates an action plan in the section between the start point and the planned end point or in the section between the start point and the destination of automatic driving. Nevertheless, the disclosure is not limited thereto, and the action plan generation part 116 may generate an action plan for any section.

For example, the action plan is composed of a plurality of events that are to be executed sequentially. For example, the events include a deceleration event for decelerating the vehicle 1, an acceleration event for accelerating the vehicle 1, a lane keeping event for the vehicle 1 to travel without deviating from the traveling lane, a lane change event for changing the traveling lane, an overtaking event for the vehicle 1 to overtake the preceding vehicle, a branch event for the vehicle 1 to change to a desired lane at a branch point or to travel with deviating from the current traveling lane, a junction event for accelerating or decelerating the vehicle 1 and changing the traveling lane in a merging lane so as to join the main lane, or the like. For example, when a junction (branch point) is present on a toll road (for example, an expressway), the control device 100 changes the lane or maintains the lane for the vehicle 1 to travel in the direction of the destination. Therefore, when it is decided that a junction is present on the route with reference to the map information 142, the action plan generation part 116 sets a lane change event for changing the lane to a desired lane, by which the vehicle 1 can travel in the direction of the destination, between the current position (coordinates) of the vehicle 1 and the position (coordinates) of the junction. The information indicating the action plan generated by the action plan generation part 116 is stored in the storage part 140 as action plan information 146.

The target traveling state setting part 118 is configured to set a target traveling state, which is a traveling state targeted by the vehicle 1, based on the action plan determined by the action plan generation part 116 and various types of information acquired by the external condition acquisition part 12, the route information acquisition part 13, and the traveling state acquisition part 14. The target traveling state setting part 118 includes a target value setting part 52 and a target trajectory setting part 54. The target traveling state setting part 118 also includes a deviation acquisition part 42 and a correction part 44.

The target value setting part 52 is configured to set information of the traveling position (latitude, longitude, altitude, coordinates, etc.) targeted by the vehicle 1 (simply referred to as the target position), target value information of the vehicle speed (simply referred to as the target vehicle speed), and target value information of the yaw rate (simply referred to as the target yaw rate). The target trajectory setting part 54 is configured to set information of the target trajectory of the vehicle 1 (simply referred to as the target trajectory) based on the external condition acquired by the external condition acquisition part 12 and the traveling route information acquired by the route information acquisition part 13. The target trajectory includes information of the target position for each unit time. Attitude information (traveling direction) of the vehicle 1 is associated with each target position. In addition, target value information such as the vehicle speed, acceleration, yaw rate, lateral G, steering angle, steering angle speed, steering angle acceleration, or the like may be associated with each target position. The above target position, target vehicle speed, target yaw rate, and target trajectory are information indicating the target traveling state.

The deviation acquisition part 42 is configured to acquire a deviation of the actual traveling state with respect to the target traveling state based on the target traveling state set by the target traveling state setting part 118 and the actual traveling state acquired by the traveling state acquisition part 14.

The correction part 44 is configured to correct the target traveling state according to the deviation acquired by the deviation acquisition part 42. Specifically, as the deviation increases, the target traveling state set by the target traveling state setting part 118 is brought closer to the actual traveling state acquired by the traveling state acquisition part 14 to set a new target traveling state.

The traveling control part 120 is configured to control the traveling of the vehicle 1. Specifically, a command value of traveling control is outputted to make the traveling state of the vehicle 1 coincide with or close to the target traveling state set by the target traveling state setting part 118 or the new target traveling state set by the correction part 44. The traveling control part 120 includes an acceleration/deceleration command part 56 and a steering command part 58.

The acceleration/deceleration command part 56 is configured to perform acceleration/deceleration control in the traveling control of the vehicle 1. Specifically, the acceleration/deceleration command part 56 calculates an acceleration/deceleration command value for making the traveling state of the vehicle 1 coincide with the target traveling state based on the target traveling state (target acceleration/deceleration) set by the target traveling state setting part 118 or the correction part 44 and the actual traveling state (actual acceleration/deceleration).

The steering command part 58 is configured to perform steering control in the traveling control of the vehicle 1. Specifically, the steering command part 58 calculates a steering angle speed command value for making the traveling state of the vehicle 1 coincide with the target traveling state based on the target traveling state set by the target traveling state setting part 118 or the correction part 44 and the actual traveling state.

FIG. 2 is a schematic diagram showing a configuration of the traveling driving force output device 90 provided in the vehicle 1. As shown in FIG. 2, the traveling driving force output device 90 of the vehicle 1 of the present embodiment includes the internal combustion engine (engine) EG as the drive source, and the automatic transmission TM connected to the engine EG via a torque converter TC with a lockup clutch. The automatic transmission TM is a transmission that shifts the rotation of the driving force transmitted from the engine EG and outputs it to the drive wheel side, and it is a stepped automatic transmission that can set multiple shift stages for forward traveling and one shift stage for reverse traveling. Further, the traveling driving force output device 90 includes the FI-ECU (fuel injection control device) 4 for electronically controlling the engine EG, the AT-ECU (automatic shift control device) 5 for electronically controlling the automatic transmission TM including the torque converter TC, and a hydraulic pressure control device 6 for hydraulically controlling the rotational driving or lockup control of the torque converter TC and the (fastening) engagement/disengagement of a plurality of friction engagement mechanisms provided in the automatic transmission TM under control of the AT-ECU 5.

The rotational output of the engine EG is outputted to a crankshaft (the output shaft of the engine EG) 221 and transmitted to an input shaft 227 of the automatic transmission TM via the torque converter TC.

A crankshaft rotation speed sensor 201 is provided for detecting the rotation speed Ne of the crankshaft 221 (the engine EG). Further, an input shaft rotation speed sensor 202 provided for detecting the rotation speed (the input shaft rotation speed of the automatic transmission TM) Ni of the input shaft 227. An output shaft rotation speed sensor 203 is provided for detecting the rotation speed (the output shaft rotation speed of the automatic transmission TM) No of the output shaft 228. The rotation speed data Ne, Ni, and No detected by the respective sensors 201 to 203 and the vehicle speed data calculated based on the rotation speed data No are given to the AT-ECU 5. In addition, the engine rotation speed data Ne is given to the FI-ECU (fuel injection control device) 4. Further, a throttle opening degree sensor 206 is provided for detecting the throttle opening degree TH of the engine EG. Data of the throttle opening degree TH is given to the FI-ECU 4.

Moreover, the AT-ECU 5 that controls the automatic transmission TM has a shift map (shift characteristic) 55 defining the region of a shift stage that can be set by the automatic transmission TM according to the vehicle speed detected by the vehicle speed sensor and the accelerator opening degree detected by the accelerator opening degree sensor 71. The shift map 55 includes an upshift line and a downshift line set for each shift stage, and multiple types of shift maps having different characteristics are prepared in advance. In the shift control of the automatic transmission TM, the AT-ECU 5 performs control to switch the shift stage of the automatic transmission TM according to the shift map selected from the multiple types of shift maps.

### [Overview of Automatic Driving Control]

In the vehicle 1, when the automatic driving mode is selected by the driver's operation of the changeover switch 80, the automatic driving control part 110 performs automatic driving control of the vehicle 1. In the automatic driving control, the automatic driving control part 110 determines the current traveling state (actual traveling trajectory, traveling position, etc.) of the vehicle 1 based on the information acquired from the external condition acquisition part 12, the route information acquisition part 13, the traveling state acquisition part 14, etc. or the information recognized by the own vehicle position recognition part 112 and the outside recognition part 114. The target traveling state setting part 118 sets the target traveling state (target trajectory and target position), which is the traveling state targeted by the vehicle 1, based on the action plan generated by the action plan generation part 116. The deviation acquisition part 42 acquires the deviation of the actual traveling state with respect to the target traveling state. When the deviation is acquired by the deviation acquisition part 42, the traveling control part 120 performs traveling control so as to make the traveling state of the vehicle 1 coincide with or close to the target traveling state.

The correction part 44 corrects the target trajectory or the target position based on the traveling position acquired by the traveling position acquisition part 26. The traveling control part 120 controls acceleration and deceleration of the vehicle 1 by the traveling driving force output device 90 and the brake device 94 based on the vehicle speed, etc. acquired by the vehicle speed acquisition part for the vehicle 1 to follow the new target trajectory or target position.

The correction part 44 also corrects the target trajectory based on the traveling position acquired by the traveling position acquisition part 26. The traveling control part 120 performs steering control by the steering device 92 based on the steering angle speed acquired by the steering angle acquisition part 32 for the vehicle 1 to follow the new target trajectory.

[Shift Stage Switching Control during Automatic Driving]

Then, if there is a request for changing the lane on which the vehicle 1 is traveling or for acceleration or deceleration while the vehicle 1 is traveling under the above-mentioned automatic driving control, in the control device 100 for the vehicle 1 according to the present embodiment, a maximum acceleration Gmax and a minimum acceleration Gmin of the vehicle 1 are calculated by using the external condition of the vehicle 1 acquired by the external condition acquisition part 12, a target acceleration Gt is calculated by comparing the calculated maximum acceleration Gmax and minimum acceleration Gmin with a preset optimum acceleration (ideal acceleration Gi), a target shift stage SHt of the automatic transmission TM is calculated based on the current state of the engine EG in accordance with the calculated target acceleration Gt, a standby pressure Pm for the clutch (friction fastening element) of the calculated target shift stage SHt is calculated, and standby pressure control of the clutch is performed with the calculated standby pressure Pm, as the acceleration priority shift control that selects the shift stage set by the automatic transmission TM by preferentially using the information of acceleration of the vehicle 1. The acceleration priority shift control will be described below.

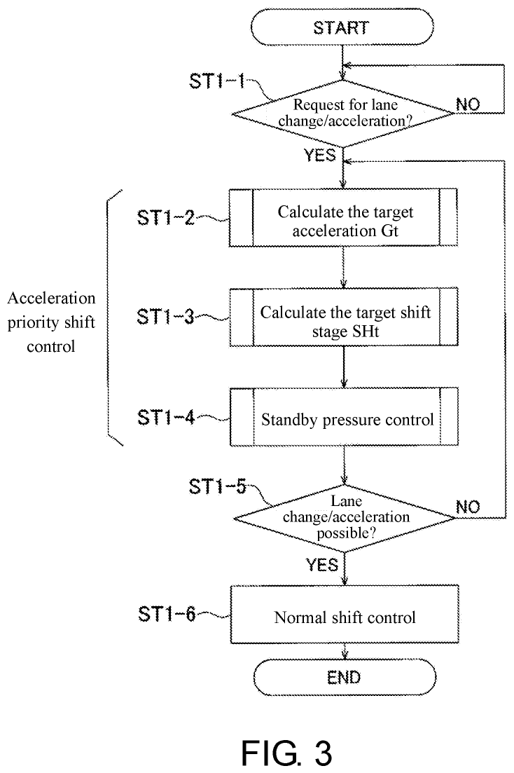

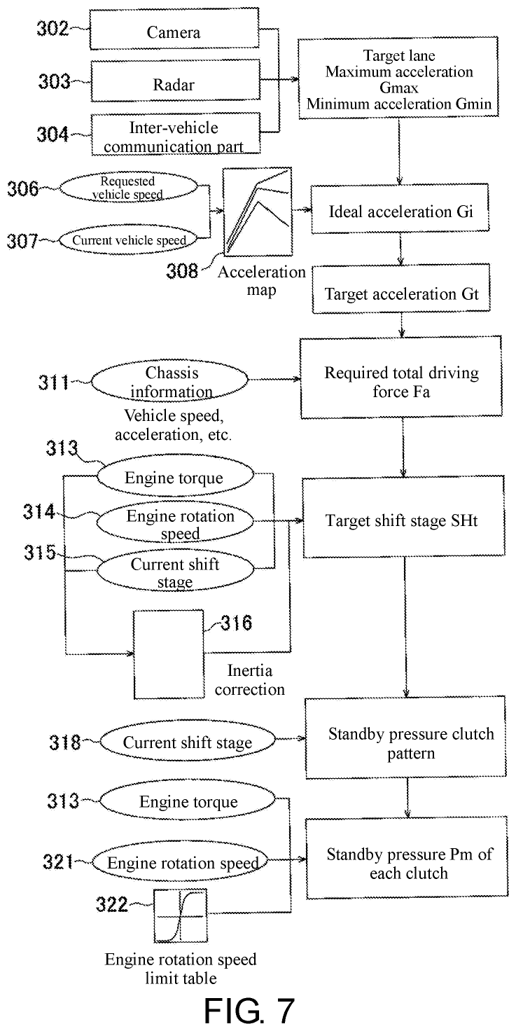

FIG. 3 to FIG. 6 are flowcharts for illustrating the procedures of acceleration priority shift control. Further, FIG. 7 is a diagram for illustrating the data used for each value calculated by the acceleration priority shift control. The procedures of the acceleration priority shift control will be described with reference to these figures. FIG. 3 is a basic flow of the acceleration priority shift control. As shown in FIG. 3, in the acceleration priority shift control, whether there is a lane change request or an acceleration request is determined first (ST1-1). As a result, if there is no lane change request or acceleration request (NO), it stands by until there is a request. If there is a lane change request or an acceleration request (YES), then the target acceleration Gt is calculated (ST1-2).

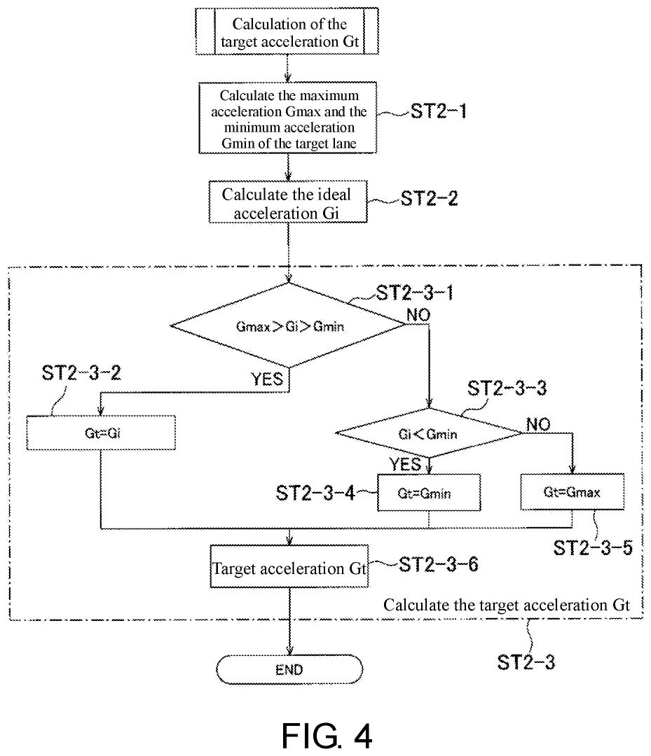

FIG. 4 is a flowchart for illustrating a procedure of calculating the target acceleration Gt. In the calculation of the target acceleration Gt, first, the maximum acceleration Gmax and the minimum acceleration Gmin of the target lane are calculated (ST2-1). Regarding the maximum acceleration Gmax, as shown in FIG. 7, it is the safe maximum acceleration that is inversely calculated from the preceding vehicle distance and preceding vehicle speed on the target lane and the current lane based on the information of the camera 302, the radar 303, and the inter-vehicle communication part 304, and can avoid collision due to acceleration. On the other hand, the minimum acceleration Gmin is inversely calculated from the following vehicle distance and following vehicle speed on the target lane in order to avoid collision with the following vehicle due to lane change.

Returning to the flow of FIG. 4, then the ideal acceleration (optimum acceleration) Gi is calculated (ST2-2). As shown in FIG. 7, the ideal acceleration Gi is calculated from an acceleration map 308 created based on information of the requested vehicle speed 306 and the present vehicle speed (current vehicle speed) 307. The acceleration map 308 is a two-dimensional map in which the vertical axis represents the target vehicle speed and the horizontal axis represents the present vehicle speed (current vehicle speed). The acceleration map 308 is defined from perspectives such as the acceleration, which the occupant would feel most comfortable with, from a constant vehicle speed based on a human sensitivity evaluation value, and the continuous acceleration time due to the difference between the target vehicle speed and the constant vehicle speed.

Next, the target acceleration Gt is calculated (ST2-3). In the calculation of the target acceleration Gt, first the maximum acceleration Gmax and the minimum acceleration Gmin calculated in ST2-1 are compared with the ideal acceleration Gi calculated in ST2-2 to determine whether “maximum acceleration Gmax>ideal acceleration Gi>minimum acceleration Gmin” (ST2-3-1). As a result, if “maximum acceleration Gmax>ideal acceleration Gi>minimum acceleration Gmin” is satisfied (YES), it is set that target acceleration Gt=ideal acceleration Gi (ST2-3-2). On the other hand, if “maximum acceleration Gmax>ideal acceleration Gi>minimum acceleration Gmin” is not satisfied (NO), whether “ideal acceleration Gi<minimum acceleration Gmin” is determined (ST2-3-3). As a result, if “ideal acceleration Gi<minimum acceleration Gmin” is satisfied (YES), it is set that target acceleration Gt=minimum acceleration Gmin (ST2-3-4). However, if “ideal acceleration Gi<minimum acceleration Gmin” is not satisfied (NO), it is set that target acceleration Gt=maximum acceleration Gmax (ST2-3-5). In this manner, the target acceleration Gt is calculated (ST2-3-6).

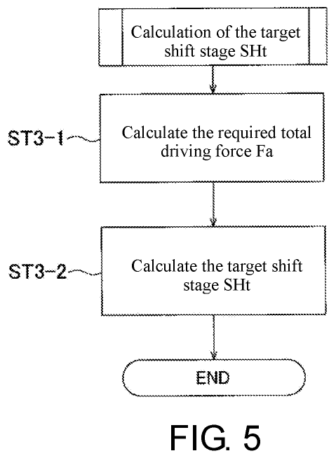

Next, returning to the flow of FIG. 3, the target shift stage SHt is calculated (ST1-3). FIG. 5 is a flowchart for illustrating the procedure of calculating the target shift stage SHt. In the calculation of the target shift stage SHt, a required total driving force Fa is calculated first (ST3-1). As shown in FIG. 7, the required total driving force Fa is calculated based on chassis information 311 such as the speed and acceleration of the vehicle 1. That is, regarding the calculation of the required total driving force Fa, in addition to the target acceleration Gt calculated in the previous step, the required total driving force Fa for realizing the target acceleration Gt from the current state is calculated based on the chassis information 311 such as the present vehicle speed and acceleration.

Subsequently, the target shift stage SHt is calculated (ST3-2). As shown in FIG. 7, the target shift stage SHt is calculated based on information such as the engine torque 313, the engine rotation speed 314, and the present shift stage (current shift stage) 315. In this case, the values obtained by adding inertia correction 316 to the values of the engine torque 313, the engine rotation speed 314, and the present shift stage (current shift stage) 315 are used. With respect to the inertia correction 316, when setting the actual data, there is a discrepancy between the signal sent from the engine EG, etc. and the actual value, and particularly regarding the engine torque 313 (FI torque), it is necessary to add a correction gain in order to calculate a value closer to the actual torque, and the inertia correction 316 makes correction for further improving the flexibility of setting.

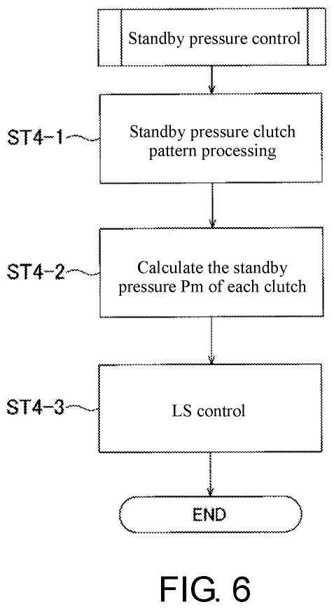

Next, returning to the flow of FIG. 3, standby pressure control is performed (ST1-4). FIG. 6 is a flowchart for illustrating the procedure of standby pressure control. In the standby pressure control, standby pressure clutch pattern processing is performed first (ST4-1). As for the standby pressure clutch pattern processing, since different shift stages of a stepped automatic transmission (multi-step transmission) are formed with different clutch fastening patterns, when the target shift stage is decided, processing for determining the clutch pattern to be processed is performed in order to determine the standby pressure according to the present shift stage. The standby pressure clutch pattern is calculated based on the current shift stage 318 as shown in FIG. 7.

Next, the standby pressure Pm of each clutch is calculated (ST4-2). As shown in FIG. 7, the standby pressure Pm of each clutch is calculated based on the engine torque 313, the engine rotation speed 321, and the engine rotation speed limit table 322. Here, the engine rotation speed limit table 322 is a table for limiting the engine rotation speed corresponding to the clutch standby pressure Pm. The purpose of limiting the engine rotation speed is that when a standby pressure is given to the clutch, it is concerned that a blow-up speed may occur in the engine EG due to the traveling condition of the vehicle, but by adding an engine rotation speed limit to the standby pressure, the acceleration of the vehicle 1 can be changed smoothly. That is, in order to ensure occupant comfort (ride comfort), the standby pressure is limited with the engine rotation speed, and when the actual engine rotation speed rises above the specified engine rotation speed, the standby pressure of the clutch (the command value of the linear solenoid valve described later) is defined by the limit value.

Furthermore, when the vehicle travels at a constant vehicle speed, entering a clutch other than the current shift stage will increase the ratio on the drive wheel side, so there is a possibility that the vehicle speed (vehicle body speed) cannot be maintained, and the sudden deceleration may make the occupant feel uncomfortable. To cope with this, limiting the engine rotation speed 314 can prevent an excessive rise (blow-up) of the rotation speed of the engine EG.

Therefore, by limiting the engine rotation speed in the standby pressure control, it is possible to reduce both the blow-up of the engine EG and deceleration. The value of the output shaft in the engine rotation speed limit table 322 can be the rotation speed of the engine EG, and the value of the input shaft can be a value that can reflect the sensibility of the occupant, such as the value of the sound characteristic of the vehicle, for example. Alternatively, the engine rotation speed limit table (the limit value of the engine rotation speed) 322 may be a fixed value that has a constant output value.

Thereafter, the linear solenoid valve (LS) is controlled with the calculated standby pressure (ST4-3), thereby controlling the standby pressure of the clutch of the corresponding shift stage.

Returning to the flow of FIG. 3, when the acceleration priority shift control (ST1-2 to ST1-4) is over, it is determined whether it is possible to make a lane change or accelerate based on the request in ST1-1 above (ST1-5). As a result, if it is possible to make a lane change or accelerate based on the request (YES), normal shift control (ST1-6) is performed instead of acceleration priority shift control from then. The normal shift control mentioned here is the conventional shift control that selects a shift stage of the automatic transmission TM based on the accelerator pedal opening degree signal or the vehicle speed feedback signal. On the other hand, if it is not possible to make a lane change or accelerate in ST1-5 (NO), then the acceleration priority shift control (ST1-2 to ST1-4) is continued.

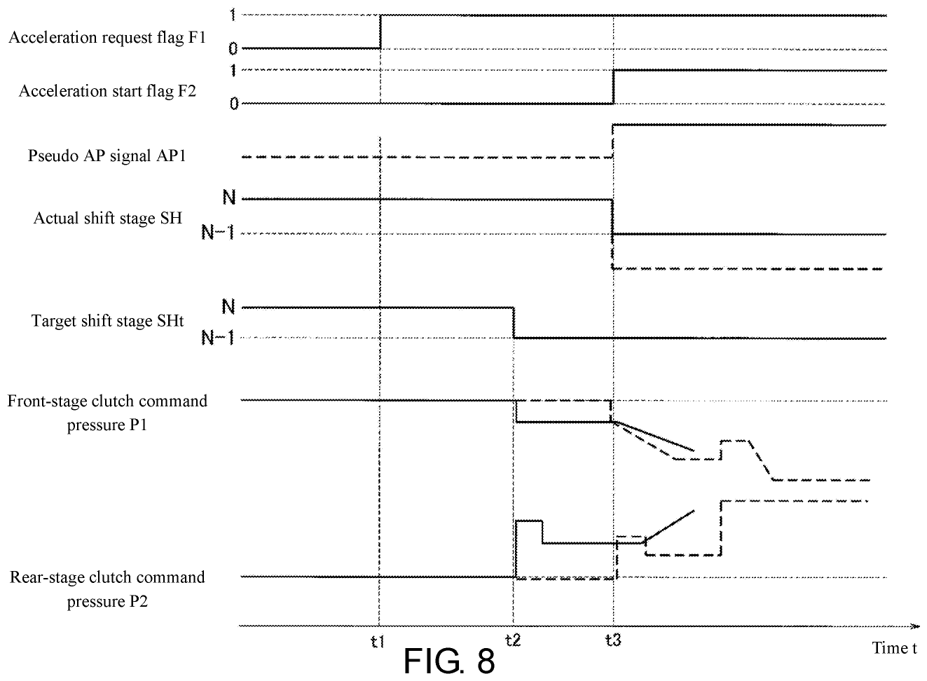

FIG. 8 is a timing chart for illustrating the contents of the acceleration priority shift control. The timing chart of FIG. 8 shows an acceleration request flag F1, an acceleration start flag F2, a pseudo accelerator pedal (AP) signal AP1, the actual shift stage SH, the target shift stage SHt, a front-stage clutch command pressure P1, a rear-stage clutch command pressure P2, and their changes with respect to the elapsed time t. In addition, regarding the line that shows the change of each value, the solid line is a line of the control according to the disclosure, and the dotted line shows the change (conventional change) when the control of the disclosure is not performed for reference. As shown in the timing chart of FIG. 8, in the acceleration priority shift control, first the acceleration request flag is turned on (0→1) at the time t1, and an acceleration request is issued. Thereafter, at the time t2, the target shift stage SHt calculated by the procedure shown in FIG. 3 above is downshifted from the N stage to the N−1 stage. Thus, at the same time, the front-stage (N stage) clutch command pressure P1 starts to drop from engagement to disengagement, and the rear-stage (N−1 stage) clutch command pressure P2 starts to rise from disengagement to engagement. Then, at the time t3, the front-stage clutch command pressure P1 drops to a predetermined pressure and the rear-stage clutch command pressure P2 rises to a predetermined pressure, whereby the actual shift stage SH changes from the N stage to the N−1 stage. At the same time, the acceleration start flag F2 is turned on (0→1), and the pseudo accelerator pedal signal AP1 rises to a predetermined value.

Conventionally, the shift control is started after acceleration is started. In contrast thereto, the acceleration priority shift control of the present embodiment can determine the target shift stage before acceleration, independent of the pseudo accelerator pedal signal AP1. Therefore, the shift control can be started before acceleration is started (before the acceleration start flag F2 is turned on). Since the front-stage clutch command pressure P1 and the rear-stage clutch command pressure P2 can be adjusted in advance by clutch control, the occurrence of shift shock can be reduced more reliably. Also, in the control of the disclosure, the target shift stage is determined on the acceleration basis, so the target shift stage may be different from that of the conventional control.

Moreover, in the acceleration priority shift control of the present embodiment, the target shift stage SHt is calculated in advance based on the vehicle body signal such as the chassis information 311 without depending on the pseudo accelerator pedal signal AP1. Therefore, the occurrence of shift shock can be reduced more effectively, and acceleration comfortable for the occupant can be realized. Further, since the target shift stage is determined on the acceleration basis, the shift pattern may be a shift pattern different from that of the conventional control.

In the timing chart of FIG. 8, the reason why there is a time lag between the turning on of the acceleration request flag F1 and the turning on of the acceleration start flag F2 is that, when a command of lane change or acceleration is issued, there is a control determination time for safety determination. Moreover, in the case of lane change, it takes time to calculate the information from the sensors, or when the vehicle 1 moves to the adjacent lane, it takes time for the control of the electric power steering (EPS) system to start or for the actuator to actually operate.

As described above, in the control device for the vehicle 1 according to the present embodiment, under selection control of the shift stage set by the automatic transmission TM, the target shift stage is determined based on the target acceleration of the vehicle 1, so that it is possible to determine the target shift stage with acceleration considering the condition of the lane traveled by the vehicle 1 based on the optimum acceleration. Therefore, the target shift stage of the automatic transmission TM is determined before the actual acceleration is permitted based on information such as the accelerator pedal opening degree, and the standby pressure of the friction fastening element corresponding to the target shift stage is controlled, thereby effectively reducing the occurrence of shift shock. In addition, since it is unnecessary to downshift in advance, the occupant will not feel uncomfortable due to an excessive rise (blow-up) of the rotation speed of the engine EG caused by the downshift.

Although embodiments of the disclosure have been described above, the disclosure is not limited to the above embodiments, and it is possible to make various modifications within the scope of the claims and the scope of the technical ideas described in the specification and drawings. For example, the automatic driving mode at the time when the above-mentioned shift stage switching control is executed is for automatically controlling both the steering angle and the acceleration and deceleration of the vehicle 1. However, in addition thereto, the driving mode at the time when target acceleration correction control is executed may be the semi-automatic driving mode which automatically controls only the acceleration and deceleration of the vehicle 1.

What is claimed is:

1. A control device for a vehicle, comprising an automatic driving control part that performs an automatic driving control for automatically controlling at least acceleration and deceleration of the vehicle, the control device for the vehicle comprising:
an automatic transmission shifting a rotation of a driving force transmitted from a drive source of the vehicle and outputting the driving force to a drive wheel side,
wherein the automatic transmission is a stepped automatic transmission capable of setting a plurality of shift stages having different gear ratios, and
the control device comprises:
a traveling control part outputting a command value of a traveling control which comprises a selection of a shift stage set by the automatic transmission,
wherein, as an acceleration priority shift control that selects the shift stage set by the automatic transmission by preferentially using an information of acceleration of the vehicle, the traveling control part:
calculates a maximum acceleration and a minimum acceleration of the vehicle by using an external information of the vehicle acquired by an external information acquisition part;
calculates a target acceleration by comparing the calculated maximum acceleration and minimum acceleration with a preset optimum acceleration;
calculates a target shift stage of the automatic transmission based on a current state of the drive source in accordance with the calculated target acceleration; and
calculates a standby pressure for a friction fastening element of the calculated target shift stage, and performs a standby pressure control of the friction fastening element with the calculated standby pressure.

2. The control device for the vehicle according to claim 1, wherein as a selection control of the shift stage of the automatic transmission, the traveling control part is capable of selectively performing the acceleration priority shift control and a normal shift control, in which the normal shift control selects the shift stage of the automatic transmission based on an accelerator pedal opening degree signal or a vehicle speed feedback signal, and
in the acceleration priority shift control, the acceleration priority shift control is shifted to the normal shift control after determining that it is possible for the vehicle to change a lane or accelerate at a requested acceleration.

3. The control device for the vehicle according to claim 1, wherein the external information acquisition part comprises at least one of an imaging device capable of imaging outside of the vehicle, a radar detection part acquiring the external information of the vehicle by a radar, and an inter-vehicle communication part capable of communicating with another vehicle.

4. The control device for the vehicle according to claim 2, wherein the external information acquisition part comprises at least one of an imaging device capable of imaging outside of the vehicle, a radar detection part acquiring the external information of the vehicle by a radar, and an inter-vehicle communication part capable of communicating with another vehicle.

5. The control device for the vehicle according to claim 1, wherein the drive source is an engine, and
in the standby pressure control of the friction fastening element, an engine rotation speed limit that limits a rotation speed of the engine to a predetermined rotation speed or less is performed.

6. The control device for the vehicle according to claim 2, wherein the drive source is an engine, and
in the standby pressure control of the friction fastening element, an engine rotation speed limit that limits a rotation speed of the engine to a predetermined rotation speed or less is performed.

7. The control device for the vehicle according to claim 3, wherein the drive source is an engine, and
in the standby pressure control of the friction fastening element, an engine rotation speed limit that limits a rotation speed of the engine to a predetermined rotation speed or less is performed.

8. The control device for the vehicle according to claim 4, wherein the drive source is an engine, and
in the standby pressure control of the friction fastening element, an engine rotation speed limit that limits a rotation speed of the engine to a predetermined rotation speed or less is performed.
